(19) United States
(12) Patent Application Publication
(10) Pub. No.: US 2016/0156117 A1
(43) Pub. Date: Jun. 2, 2016

(54) CARD EDGE CONNECTOR WITH LOCKING DEVICE

(71) Applicant: FOXCONN INTERCONNECT TECHNOLOGY LIMITED, Grand Cayman (KY)

(72) Inventors: ZHEN-HUA WANG, Kunshan (CN); QIANG FANG, Kunshan (CN)

(21) Appl. No.: 14/954,950

(22) Filed: Nov. 30, 2015

(30) Foreign Application Priority Data
Nov. 28, 2014 (CN) 201420728737.0

(51) Int. Cl. H01R 12/70; H01R 12/73

(52) U.S. Cl. CPC H01R 12/7047; H01R 12/73

(57) ABSTRACT

A card edge connector for connecting an electrical card to a PCB (printed circuit board), includes a terminal block with an elongate inserting slot for the electrical card to insert into and at least a locking device separate from the terminal block. The locking device includes at least one supporting portion and at least one locking portion. The supporting portion defines a blind hole by downwardly recessing an upper surface thereof for mating with the locking portion, and includes a mounting portion opposite to the blind hole along a vertical direction for retaining the supporting portion to the PCB. The electrical card is positioned and retained between the locking portion and the supporting portion. The locking device would make good use of a space of the PCB.

### BACKGROUND OF THE INVENTION

1. Field of the Invention

The present invention relates to a card edge connector, more particularly to a card edge connector with a reliable locking device.

2. Description of Related Art

U.S. Pat. No. 7,134,896 issued on Nov. 14, 2006, discloses a card edge connector for connecting an electrical card to a Printed Circuit Board (PCB). The card edge connector includes an inserting portion and a locking portion separating from each other. The inserting portion is elongate shape and includes an elongate inserting slot parallel to the PCB for receiving the electrical card. The locking portion is elongate shape and includes a pair of elastic arms and a pair of operating portions defined in both sides thereof in a longitudinal direction facing to the inserting slot for operating the elastic arms, which can ensure the stability connection between the electrical card and the PCB. The inserting portion and the locking portion could be stacked for retaining multiple electrical cards.

However, when electronic devices become miniaturization and close packed, the aforementioned card edge connector needs a large area for mounting the locking portion and an extra area for operating the elastic arms which is going against the miniaturization. Further more, the locking portion is defined for retaining a discrete electrical card within the aforementioned inserted mode. When the card edge connector is used for retaining multiple electrical cards in the same inserted mode, it will increase the difficulty the connector wiring in the PCB.

Hence, an improved card edge connector is required to overcome the disadvantages of the related art.

### BRIEF SUMMARY OF THE INVENTION

Accordingly, the object of the present invention is to provide a card edge connector with a locking device for stable connection between an electrical card and a PCB.

In order to achieve the object reminded above, A card edge connector connecting an electrical card to a PCB is provided, comprising: a terminal block defining an elongate inserting slot for the electrical card inserted into; and at least one locking device separating from the terminal block; wherein the locking device includes at least one supporting portion and at least one locking portion, the supporting portion defines a mounting portion in the bottom thereof for retaining the supporting portion to the PCB, and the electrical card is retained between the locking portion and the supporting portion.

Other objects, advantages and novel features of the invention will become more apparent from the following detailed description when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a card edge connector according to a first embodiment of the present invention;

FIG. 2 is an exploded view of the card edge connector shown in FIG. 1;

FIG. 3 is a perspective view of a card edge connector according to a second embodiment of the present invention;

FIG. 4 is an exploded view of the card edge connector shown in FIG. 3;

FIG. 5 is a perspective view of a card edge connector according to a third embodiment of the present invention;

FIG. 6 is a side view of the connector shown in FIG. 5; and

FIG. 7 is a perspective view of a card edge connector according to a fourth embodiment of the present invention.

### DETAILED DESCRIPTION OF THE PREFERRED EMBODIMENTS

Reference will be made to the drawing figures to describe the present invention in detail, wherein depicted elements are not necessarily shown to scale and wherein like or similar elements are designated by same or similar reference numeral through the several views and same or similar terminology.

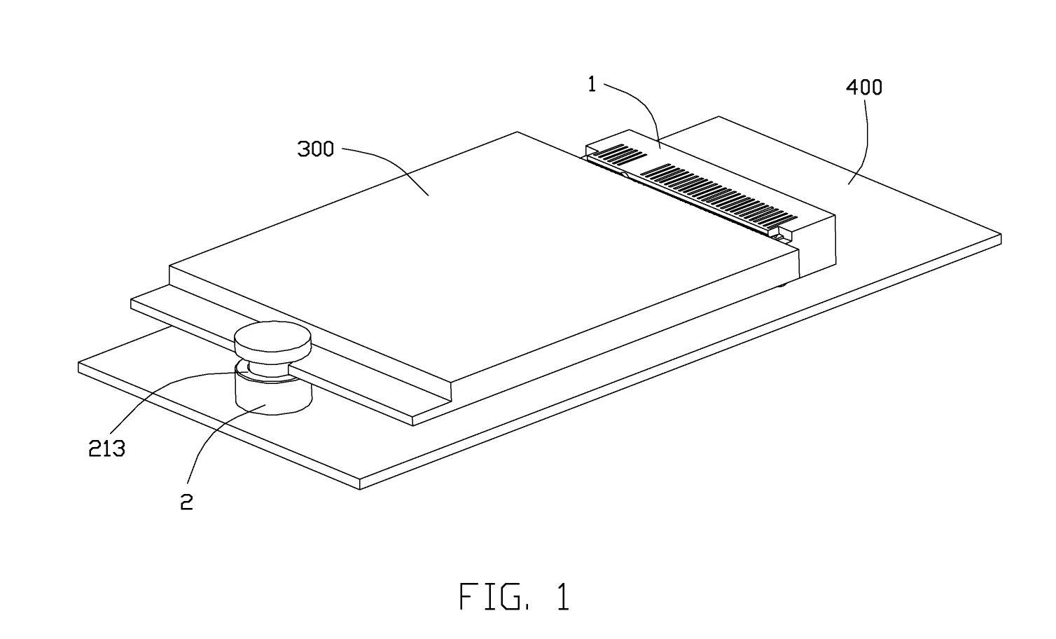

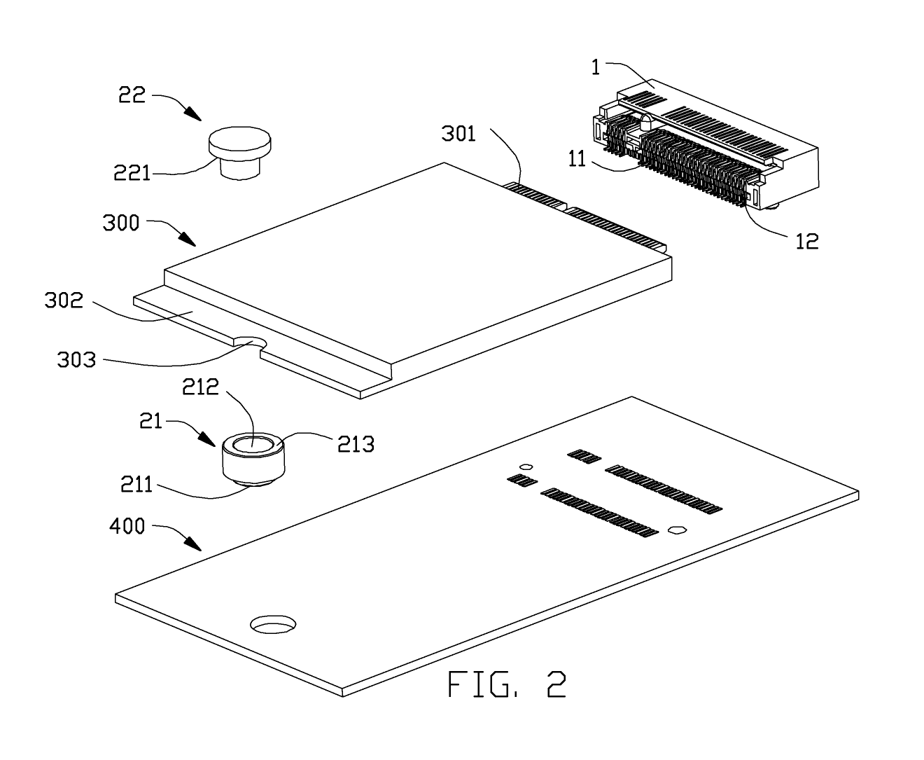

Referring to FIG. 1 and FIG. 2, a first embodiment of the invention shows a low profile card edge connector used for connecting an electrical card 300 to a PCB 400 (Printed circuit Board). The card edge connector includes a terminal block 1 and a locking device 2 independent from the terminal block 1. The card edge connector is fixed on the PCB 400 and transmitting a signal from the electrical card 300 to the PCB 400. The terminal block 1 includes an elongate inserting slot 11 recessing from a front surface thereof and a plurality of contacts 12 protruding into the inserting slot 11. Each contact 12 has one end protruding into the inserting slot 11 for contacting with the electrical card 300 and the other end extending outside of the terminal block 1 for electrically communication with the PCB 400. While the locking device 2 is defined for the mating electrical card 300 retained on the PCB 400 and ensures a stable electrically connection between the electrical card 300 and the terminal block 1.

The locking device 2 includes at least one supporting portion and at least one locking portion. Preferably, the supporting portion is a nut and the locking portion is a screw screwed into the supporting portion. Alternatively, the supporting portion also could be a screw (not shown) and the locking portion could be a nut (not shown). Moreover, in other embodiments of the invention, the supporting portion also could engage with the locking portion in other ways, such as clamping or soldering.

According to the present embodiment of the invention, the supporting portion includes a fixed nut 21 defining a cylindrical mounting portion 211 extending downwardly from the bottom thereof for retaining the fixed nut 21 into the PCB 400. It should be understood that the mounting portion 211 also could be retained into the PCB 400 by welding or clamping. The fixed nut 21 defines a supporting surface 213 for supporting the electrical card 300 and a blind hole 212 recessing from the supporting surface 213 with a female thread. The blind hole 212 forms a stopper in bottom thereof used to prevent the fixed nut 21 from excessively being screwed downwardly. The locking portion further includes an attachment screw 22 which defining at least one stud with a male thread, and the attachment screw 22 defines a locking surface 221 facing downwardly and abutting against the electrical card 300. When the mating edge 301 of the electrical card 300 is inserted into and positioned in the inserting slot 11 of the terminal block 1, a distal end edge 302 of the electrical card 300 opposite to mating edge 301 is rotated onto the supporting surface 213 of the fixed nut 21, then the stud or post of the attachment screw 22 is screwed into the blind hole 212 until the locking surface 221 thereof abuts against the end edge 302 of the electrical card 300. In this way, the electrical card 300 would be positioned and clamped between the locking surface 221 and the supporting surface 213. The end edge 302 of the electrical card 300 defines an opening 303 corresponding to the stud of the locking portion 22 so as to increase the interference area between the electrical card 300 and the locking device 2 for a steady retaining.

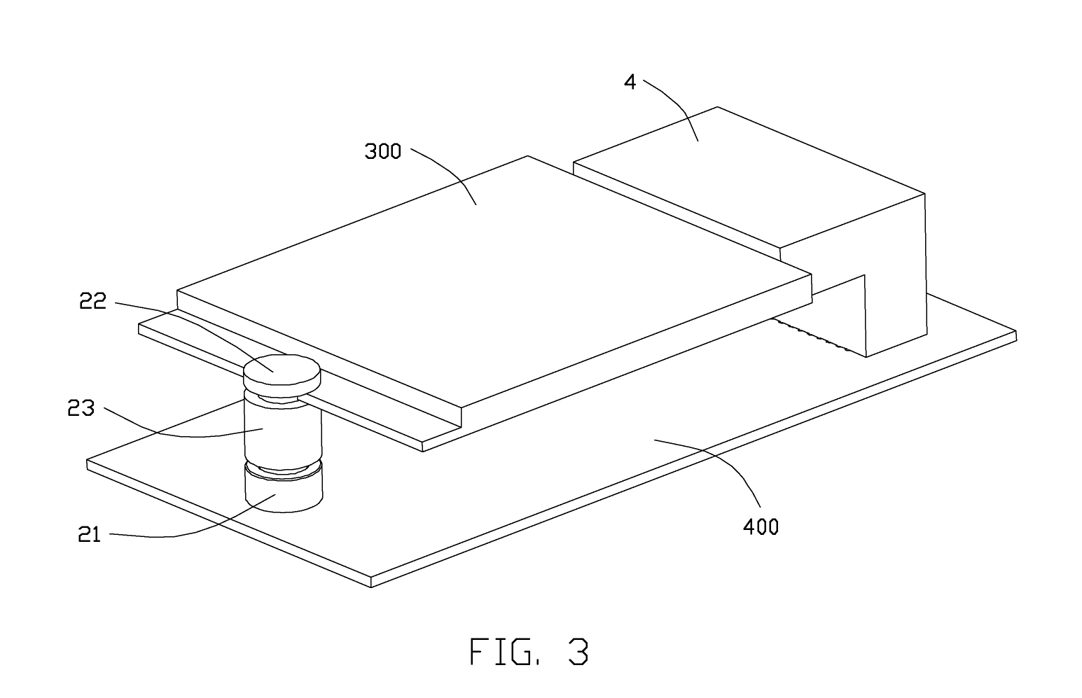

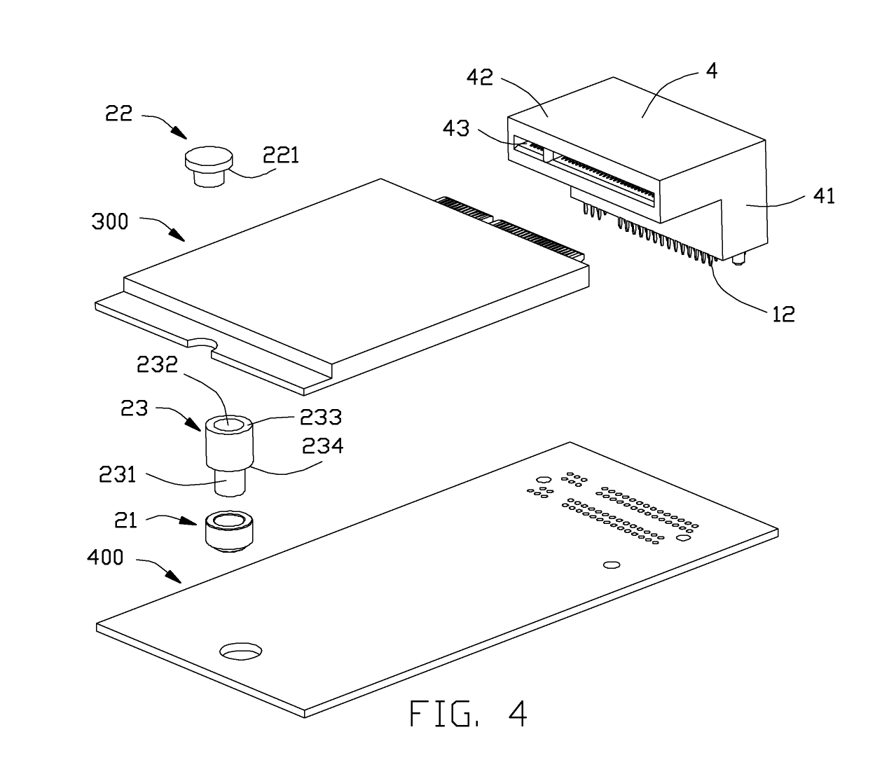

According to a second embodiment of the invention, the locking device 2 could be used in a card edge connector with a height different from the first embodiment of the invention. Referring to FIG. 3 and FIG. 4, a high profile card edge connector with a high profile terminal block 4 is disclosed. The terminal block 4 includes a base 41 and a mating portion 42 protruding forwardly from the base 41, the mating portion 42 defines an elongate inserting slot 43. Compared with the aforementioned first embodiment of the invention, there is at least one extra attendant portion 23 between the supporting portion 21 and the locking portion 22 of the locking device 2. In this invention, the attendant portion 23 is both a nut and also a screw. The attendant portion 23 defines an oppressing surface 234, a supporting surface 233 opposite to the oppressing surface 234, a blind hole 232 recessing from the supporting surface 233 for engaging the locking portion 22, and a stud 231 protruding downwardly from the oppressing surface 234 for engaging the supporting portion 21. The blind hole 232 forms a stopper in bottom thereof used to prevent the supporting portion 21 from excessively being screwed downwardly. When the electrical card 300 is assembled into the terminal block 4, the end edge 302 would be retained between the locking surface 221 of the locking portion 22 and the supporting surface 233 of the attendant portion 23. It should be noted that the height of the locking device 2 could be adjusted by adding one or several attendant portions 23.

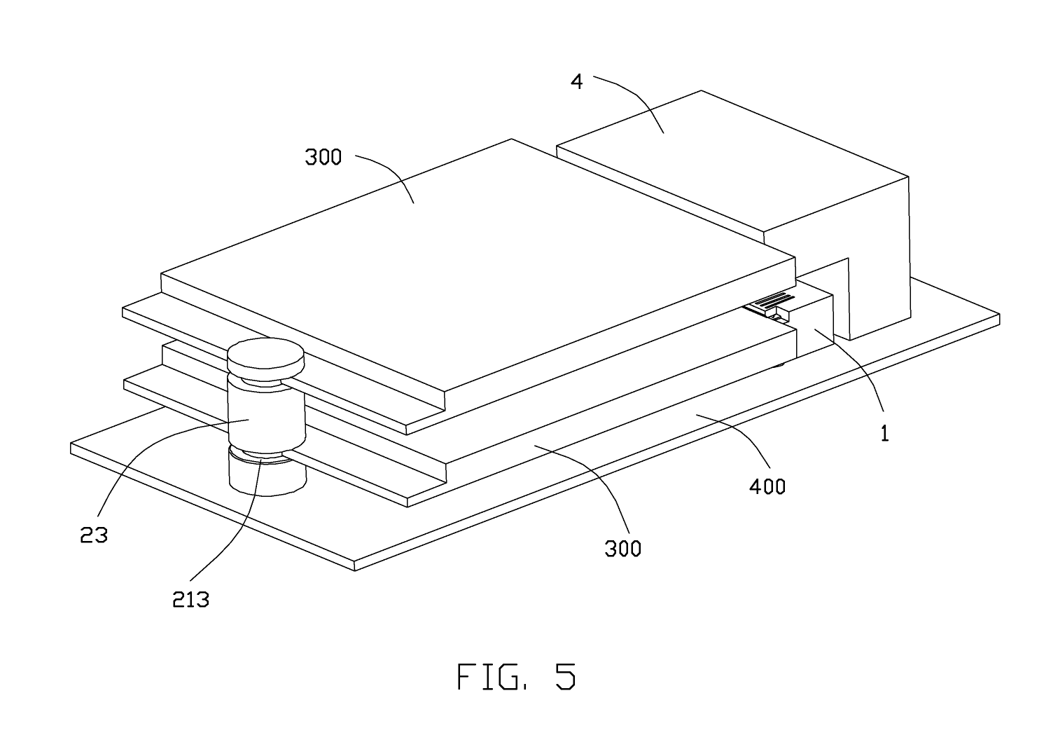

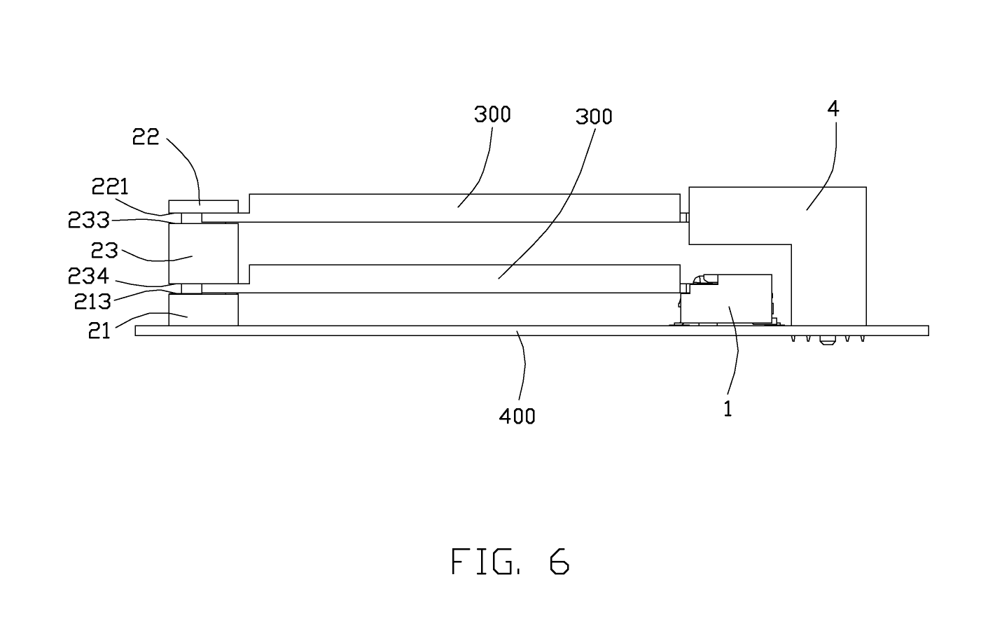

According to a third embodiment of the present invention, the locking device 2 could be used in a stacked card-edge connector engaging with two or more electrical cards 300. Referring to FIG. 5 and FIG. 6, the stacked card-edge connector includes a high-profile terminal block 4 and a low-profile terminal block 1 disposed under the high-profile terminal block 4. The high-profile terminal block 4 and the low-profile terminal block 1 respectively receive a corresponding electrical card 300 in a same direction. Similar to the locking device in the second embodiment of the invention, the locking device 2 in the third embodiment of the invention includes a supporting portion 21, a locking portion 22 and an attendant portion 23 disposed between the supporting portion 21 and the locking portion 22. In this invention, the attendant portion 23 is both a nut and also a screw. When the two electrical cards 300 are assembled, one of the electrical cards 300 would be retained between the locking surface 221 of the locking portion 22 and the supporting surface 233 of the attendant portion 23, and the other electrical card 300 would be retained between the oppressing surface 234 of the attendant portion 23 and the supporting surface 213 of the supporting portion 21.

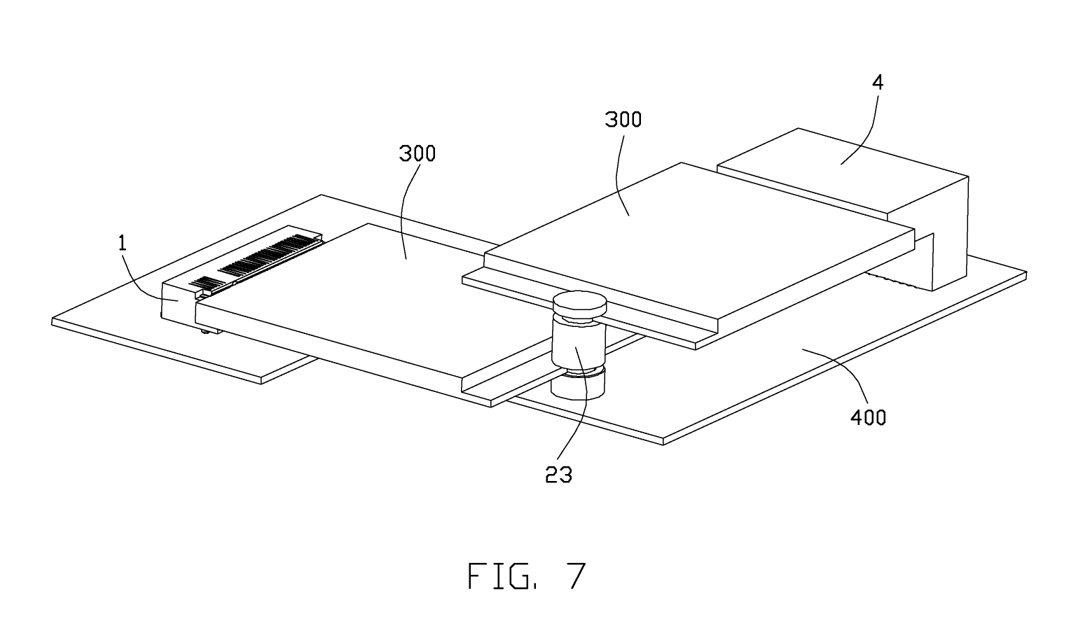

According to a fourth embodiment of the present invention, a locking device 2 could also be used in a card edge connector with two terminal blocks respectively mating with two electrical cards 300. Referring to FIG. 7, the fourth embodiment shows a high-profile terminal block 4 and a low profile terminal block 1 respectively receiving corresponding electrical cards in two different directions perpendicular to each other. Different from the third embodiment of the invention, the high profile terminal block 4 is far away from the low profile terminal block 1. As same as the description of the locking device in the third embodiment of the invention, when the two electrical cards 300 are assembled, one of the electrical cards 300 would be retained between the locking surface 221 of the locking portion 22 and the supporting surface 233 of the attendant portion 23, and the other electrical card 300 would be retained between the oppressing surface 234 of the attendant portion 23 and the supporting surface 213 of the supporting portion 21.

It should be understood that, in other embodiments of the present invention, the supporting portion could be a nut and the locking portion could be a screw (not shown), and the supporting portion and the locking portion of the locking device could also mate with each other in other ways like clamping or welding. The two terminal blocks of the card edge connector could be stacked in an up-to-down direction or arranged in a face-to-face direction relative to the locking portion or arranged perpendicular to each other relative to the locking portion.

The locking device in this invention could be used in different conditions for multiple requirements. The locking device could equip with one or several aforementioned attendant portions to retain one or several electrical cards according to the aforementioned embodiments, wherein the electrical cards could mate with the corresponding terminal blocks in a single direction or several different directions. There are fewer limits in categories or sizes of the electrical cards, and the locking device makes good use of the space occupied on the PCB, which contributes to optimizing a layout of the PCB. In another aspect, the attendant portion 23 may be regarded as the first locking portion for retaining the lower level electrical card and the locking portion 22 may be regarded as the second locking portion for retaining the higher level electrical card. Therefore, the whole assembly may be systematically arranged together in sequence.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card edge connector for connecting an electrical card to a PCB, comprising:
a terminal block defining an elongate inserting slot for the electrical card inserted into; and
at least one locking device separating from the terminal block; wherein
the locking device includes at least one supporting portion and at least one locking portion, the supporting portion defines a mounting portion in the bottom thereof for retaining the supporting portion to the PCB, and the electrical card is retained between the locking portion and the supporting portion.

2. The card edge connector as described in claim 1, wherein the supporting portion is nut-like, the locking portion is screw-like, the supporting portion defines a blind hole recessing downwardly from an upper surface thereof opposite to the mounting portion, the locking portion includes at least one stud fixed in the blind hole of the supporting portion.

3. The card edge connector as described in claim 1, wherein the locking device includes at least one attendant portion positioned between the supporting portion and the locking portion, the attendant portion includes at least one oppressing surface, and a stud protruding downwardly from the oppressing surface for mating with a blind hole formed in the supporting portion, and a supporting surface opposite to the oppressing surface, and a blind hole recessing from the supporting surface for mating with a stud formed in the locking portion.

4. The card edge connector as described in claim 3, wherein the number of the attendant portions could be adjusted to the number of the terminal blocks or the number of the electrical cards assembled.

5. The card edge connector as described in claim 3, wherein the locking portion is screwed to the attendant portion, and the locking portion defines a stud with a male-thread mating with the blind hole of the attendant portion with a female-thread, the attendant portion is screwed to the supporting portion, and the attendant portion defines a stud with a male-thread mating with the blind hole of the supporting portion with a female-thread.

6. The card edge connector as described in claim 3, wherein the electrical card could be retained between the locking portion and the attendant portion, or between the attendant portion and the supporting portion, or between the locking portion and the attendant portion, or between two attendant portions.

7. The card edge connector as described in claim 4, wherein the terminal blocks could be stacked in an up-to-down direction or arranged in a face-to-face direction around the locking portion.

8. The card edge connector as described in claim 4, wherein the terminal blocks could be arranged perpendicular to each other relative to the locking portion.

9. A locking device of a card edge connector for locking at least one electrical card, comprise:
a supporting portion and a locking portion engaging with each other, the supporting portion defining a mounting portion extending downwardly for retaining the supporting portion to a PCB, a support surface disposed on the upper surface thereof and a stopper recessing from the support surface for receiving the locking portion; wherein
the locking portion defines a locking surface and a mating portion extending downwardly from the locking surface for mating with the stopper, the electrical card is clamped between the locking surface of the locking portion and the upper surface of the supporting portion.

10. The locking device as described in claim 9, wherein the stopper is a blind hole with female-thread, the mating portion is a stud with male-thread, the locking device also defines at least an attendant portion, the attendant portion includes at least one stud corresponding to the blind hole of the supporting portion and a blind hole corresponding to the stud of the locking portion, the height of the locking device could be changed by adjusting the number of the attendant portion.

11. An electrical connector assembly comprising:
a printed circuit board (PCB) defining opposite mounting position and termination position in a front-to-back direction;
an electrical connector including a terminal block mounted on the termination position and a locking device mounted upon the mounting position,
the terminal block forming a slot and associated with a plurality of contacts extending into the slot;
an electrical card defining opposite mating end and mounting end in said front-to-back direction, said mating end received within the slot;
the locking device including a supporting portion fastened to the PCB and a locking portion located above and detachably attached to the supporting portion along a vertical direction perpendicular to said front-to-back direction; and
the mounting end of the electrical card sandwiched between a downward locking surface of the locking portion and an upward supporting surface of the supporting portion in the vertical direction.

12. The electrical connector assembly as claimed in claim 11, wherein said locking portion forms a downward post extending downwardly beyond the locking surface and into the supporting portion.

13. The electrical connector assembly as claimed in claim 12, wherein the mounting end of the electrical card forms a notch to receive the downward post therein.

14. The electrical connector assembly as claimed in claim 13, wherein a portion of said downward post is exposed to an exterior outside of the notch in said front-to-back direction.

15. The electrical connector assembly as claimed in claim 11, further including another locking portion detachably attached upon the locking portion to retain another electrical card which is mated with another slot of another terminal lock at a higher level.

16. The electrical connector assembly as claimed in claim 15, wherein said another slot of said another terminal block and said slot of said terminal block are essentially aligned with each other in the vertical direction.
